(19) United States
(12) Patent Application Publication
(10) Pub. No.: US 2025/0180227 A1
(43) Pub. Date: Jun. 5, 2025

(54) INFRASTRUCTURE HAVING A LARGE RESERVOIR AND METHOD OF OPERATING SAME

(71) Applicant: FIDUCIE DES BRAVES 2021, Québec (CA)

(72) Inventor: Louis MASSICOTTE, Quebec (CA)

(21) Appl. No.: 18/849,597

(22) PCT Filed: Mar. 24, 2023
(86) PCT No.: PCT/CA2023/050395

§ 371 Date: Sep. 23, 2024

Related U.S. Application Data
(60) Provisional application No. 63/324,285, filed on Mar. 28, 2022.
(60) Provisional application No. 63/323,204, filed on Mar. 24, 2022.

(51) Int. Cl. F24D 11/00; E04H 4/12; F24S 60/30

(52) U.S. Cl. CPC F24D 11/002; F24D 11/001; E04H 4/129; F24S 60/30

(57) ABSTRACT

There is described an infrastructure generally having a reservoir having a base having a first periphery, a wall having a first wall portion hermetically mounted to the first periphery of the base, the first wall portion upwardly protruding to a second wall portion defining a second periphery, and a top surface hermetically mounted to the second periphery of the wall, inner surfaces of the base, the wall and the top surface collectively forming a closed cavity for receiving liquid, the top surface having a depression forming an open cavity for receiving liquid. There is described a method of operating the infrastructure by at least one of heating and maintaining liquid confined within the closed cavity to a first temperature; and the liquid confined within the closed cavity at least one of heating and maintaining liquid received within the open cavity to a second temperature lower than the first temperature.

### FIELD

The improvements generally relate to large reservoirs such as pools, ponds, lagoons and the like, and more specifically relates to infrastructures, systems and methods for heating and/or maintaining such large reservoirs at a given temperature.

### BACKGROUND

The Blue Lagoon is a geothermal spa found in southwestern Iceland. The spa is supplied in hot water by a nearby geothermal power station which generates electricity using turbines ran by steam stemming from superheated water vented near a lava field. This local attraction has gained popularity worldwide as rich mineral content of the hot water can treat some skin diseases, for instance. There have been some attempts to recreate such geothermal spas in other locations, however safe lava fields are scarce so heat generation and retention remain a challenge, especially in Northern climates. There thus remains room for improvement.

### SUMMARY

There is described a heat accumulating infrastructure having a large reservoir with a closed cavity receiving hot water and a top surface depression defining an open cavity receiving cooler but yet warm water. The open cavity can be used as a pool, a pond, a lagoon or any other infrastructure suitable for recreational swimming and bathing. While the hot water contained in the closed cavity can be heated and maintained at a relatively high temperature using heat generation systems such as solar panels, geothermal heat units, hydroelectricity powered furnaces, or a combination thereof, the cooler water received in the open cavity can be in thermal communication with the hot water contained in the closed cavity through the reservoir-facing surfaces of the open cavity. When the cooler water received in the open cavity receives more heat from the hot water enclosed in the closed cavity than what is lost to a surrounding, cooler environment, the cooler water can be heated and/or maintained at a temperature found satisfactory for swimming and bathing, for instance.

In accordance with a first aspect of the present disclosure, there is provided an infrastructure comprising: a reservoir having a base having a first periphery, a wall having a first wall portion hermetically mounted to the first periphery of the base, the first wall portion upwardly protruding to a second wall portion defining a second periphery, and a top surface hermetically mounted to the second periphery of the wall, inner surfaces of the base, the wall and the top surface collectively forming a closed cavity for receiving liquid at a first temperature, the top surface having a depression forming an open cavity for receiving liquid at a second temperature lower than the first temperature.

Further in accordance with the first aspect of the present disclosure, the infrastructure can for example further comprise a heat generation unit in fluid communication with the closed cavity, the heat generation unit configured for at least one of heating and maintaining liquid confined within the closed cavity at the first temperature.

Still further in accordance with the first aspect of the present disclosure, the first temperature can for example be above about 85° C., preferably above about 90° C. and most preferably of about 95° C.

Still further in accordance with the first aspect of the present disclosure, the heat generation unit can for example include at least one of a solar panel, a geothermal heat unit, a furnace unit and a boiler unit.

Still further in accordance with the first aspect of the present disclosure, the heat generation unit can for example include a combination of at least two of the solar panel unit, the geothermal heat unit, the furnace unit and the boiler unit.

Still further in accordance with the first aspect of the present disclosure, the infrastructure can for example further comprise a transition unit in fluid communication with the open cavity and the closed cavity, the transition unit configured for cooling liquid confined within the closed cavity to the second temperature using liquid from the open cavity.

Still further in accordance with the first aspect of the present disclosure, the cooling can for example include mixing liquid from the closed cavity with liquid from the open cavity.

Still further in accordance with the first aspect of the present disclosure, the second temperature can for example be above 30° C., preferably above about 35° C. and most preferably of about 38° C.

Still further in accordance with the first aspect of the present disclosure, the liquid can for example be water.

Still further in accordance with the first aspect of the present disclosure, the reservoir can for example have a plurality of structural members within the closed cavity and extending between the base and the depression of the top surface. In some embodiments, the structural members extend vertically between an interior surface of the base and an interior surface of the depression of the top surface.

Still further in accordance with the first aspect of the present disclosure, the depression can for example be positioned at a center region of the top surface, the top surface having a flat region surrounding the center region, the flat region being in thermal communication with the closed cavity of the reservoir.

Still further in accordance with the first aspect of the present disclosure, the flat region can for example have a plurality of buildings, the plurality of lodges being heated at least in part via the liquid at the first temperature contained within the closed cavity.

Still further in accordance with the first aspect of the present disclosure, the infrastructure can for example have a hot liquid circuit in fluid communication with the closed cavity, the hot liquid circuit having one or more conduits circulating liquid at the first temperature outside the closed cavity.

Still further in accordance with the first aspect of the present disclosure, the hot liquid circuit can for example be in heat exchange communication with a plurality of buildings surrounding the infrastructure.

Still further in accordance with the first aspect of the present disclosure, the reservoir can for example have a height ranging between 1 and 5 meters, preferably between 2 and 4 meters and most preferably 3 meters.

Still further in accordance with the first aspect of the present disclosure, the depression can for example have a depth ranging between 0.25 and 3 meters, preferably between 1 and 2 meters and most preferably 1 meters.

Still further in accordance with the first aspect of the present disclosure, the closed cavity can for example have a volume ranging between 100 m³ and 10 000 m³, preferably between 500 m³ and 5 000 m³ and most preferably of 2 500 m³.

Still further in accordance with the first aspect of the present disclosure, the open cavity can for example have a volume ranging between 50 m³ and 5 000 m³, preferably between 250 m³ and 2 500 m³ and most preferably of 1 250 m³.

Still further in accordance with the first aspect of the present disclosure, the infrastructure can for example further comprise a pump configured to circulate liquid out of the open cavity, into and along the inner conduit and back into the open cavity.

In accordance with a second aspect of the present disclosure, there is provided a method of operating an infrastructure having a reservoir having an inner surface defining a closed cavity and an outer surface having a depression defining an open cavity, the method comprising: at least one of heating and maintaining liquid confined within the closed cavity to a first temperature; and the liquid confined within the closed cavity at least one of heating and maintaining liquid received within the open cavity to a second temperature, the first temperature being greater than the second temperature.

Further in accordance with the second aspect of the present disclosure, the method can for example further comprise exchanging heat between the liquid confined within the closed cavity and liquid received in the open cavity.

Still further in accordance with the second aspect of the present disclosure, the method can for example further comprise structural members extending within the closed cavity and supporting a weight of the liquid received in the open cavity.

In accordance with a third aspect of the present disclosure, there is provided a system comprising: a plurality of buildings; a heat accumulating infrastructure having a reservoir defining a first cavity containing liquid at a first temperature, the reservoir having a top surface having a depression forming a first cavity containing liquid at a second temperature lower than the first temperature; a heat generation unit in fluid communication with the first cavity, the heat generation unit configured for at least one of heating and maintaining the liquid confined within the first cavity to the first temperature; and a heat exchange circuit circulating heat extracted from the liquid at the first temperature contained in the first cavity to the plurality of buildings.

Further in accordance with the third aspect of the present disclosure, the heat exchange circuit can for example circulate a fluid heated by the liquid at the second temperature to heat exchangers of the plurality of buildings.

Still further in accordance with the third aspect of the present disclosure, the fluid can for example be one of liquid contained in the first cavity and a heated gas.

Many further features and combinations thereof concerning the present improvements will appear to those skilled in the art following a reading of the instant disclosure.

### DESCRIPTION OF THE FIGURES

In the figures,

FIG. 1 is an exploded view of an infrastructure having a large reservoir, in accordance with one or more embodiments;

FIG. 2 is a top view of the infrastructure of FIG. 1, shown in a gated community having lodging units atop the large reservoir, in accordance with one or more embodiments;

FIG. 3 is a sectional view of the infrastructure of FIG. 2, taken along section 3-3 of FIG. 2, showing an exemplary heat generation unit, in accordance with one or more embodiments; and

FIG. 4 is a sectional view of the infrastructure of FIG. 2, taken along section 4-4 of FIG. 2, showing an exemplary transition unit, in accordance with one or more embodiments.

### DETAILED DESCRIPTION

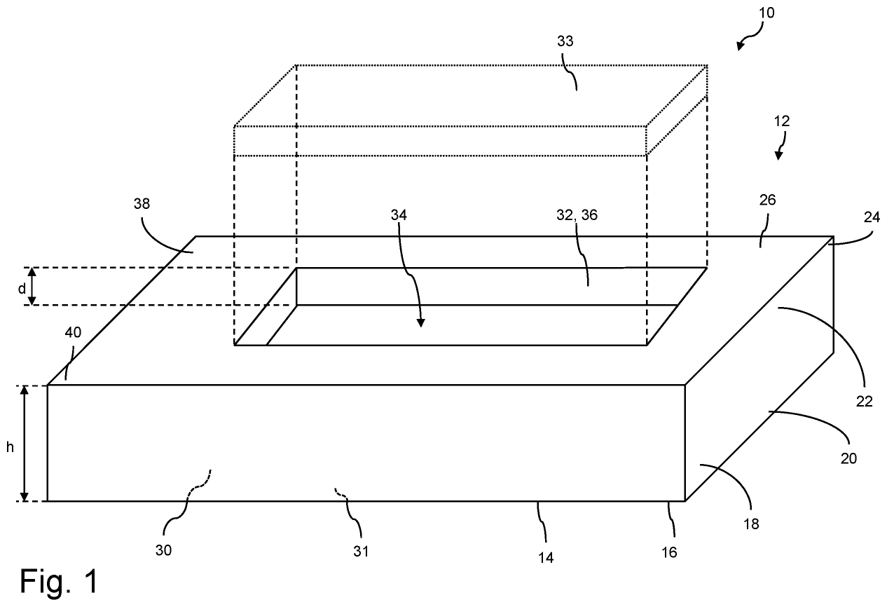

FIG. 1 shows an exploded view of an example of an infrastructure 10. The infrastructure 10 disclosed herein can be used to heat pool(s), pond(s), spa(s) which can be used for balneotherapy, hydrotherapy, recreational bathing, swimming, or a combination thereof. The infrastructure 10 can be part of a gated community, a lodge community, an hotel building, an apartment building, a condo building, a vacation resort, a village and/or a city depending on the embodiment.

As shown, the infrastructure 10 has a reservoir 12. The reservoir 12 has a base 14 having a first periphery 16. The reservoir 12 has a wall 18 having a first wall portion 20 hermetically mounted to the first periphery 16 of the base 14. The first wall portion 20 upwardly protrudes to a second wall portion 22 defining a second periphery 24. The infrastructure 10 also has a top surface 26 hermetically mounted to the second periphery 24 of the wall 18. As such, inner surfaces of the base 14, the wall 18 and the top surface 26 collectively form a closed cavity 30 for receiving liquid at a first temperature.

As depicted, the top surface 26 has a depression 32 forming an open cavity 34 for receiving liquid at a second temperature lower than the first temperature. In some embodiments, the liquid contained in both cavities 30 and 34 is the same liquid, e.g., water. In some embodiments, the first temperature is maintained above about 85° C., preferably above about 90° C. and most preferably of about 95° C. whereas the second temperature is maintained above 30° C., preferably above about 35° C. and most preferably of about 38° C. It is noted that the term “closed cavity” does not mean that the cavity 30 is completely closed at all times. The cavity 30 can be in fluid communication with openings and/or conduits allowing water to be circulated outside the cavity 30 for heating purposes, for instance. In some embodiments, the term “closed cavity” means that the cavity 30 is more closed from the surrounding environment than the open cavity 34. Similarly, the term “open cavity” means that the cavity 34 is more open to the surrounding environment than the closed cavity 30.

In some embodiments, external surfaces of the reservoir 12 that are in thermal contact with a surrounding environment (that is not the open cavity 34) are preferably thermally insulated. The thermal insulation of these external surfaces can include double or triple walls filled with air or void to provide state-of-the-art insulation. Insulation can include foam glass in some embodiments. In some embodiments, internal surfaces of the reservoir 12 that are in thermal contact with the open cavity 34 can be made to be thermally conductive at least to a certain extent. Accordingly, the significant thermal mass of the hotter body 31 of liquid at the first temperature confined within the closed cavity 30 can continuously transfer heat to the cooler body 33 of liquid at the second temperature received within the open cavity 34. In some embodiments, the closed cavity 30 has a volume greater than a volume of the open cavity 34. For instance, the volume of the closed cavity 30 can be 2, 5, or 10 times the volume of the open cavity 34 in some embodiments. It is noted that the larger the closed cavity 30, the slower the rate that the liquid confined within will cool down, and thereby cheaper the heat becomes.

The reservoir 12 can have a height h ranging between 1 and 5 meters, preferably between 2 and 4 meters and most preferably 3 meters. In some embodiments, the depression 32 has a depth d ranging between 0.25 and 3 meters, preferably between 1 and 2 meters and most preferably 1 meters. Depending on the embodiment, the closed cavity 30 can have a volume ranging between 100 m³ and 10 000 m³, preferably between 500 m³ and 5 000 m³ and most preferably of 2 500 m³. The open cavity 34 can have a volume ranging between 50 m³ and 5 000 m³, preferably between 250 m³ and 2 500 m³ and most preferably of 1 250 m³. These values are given as examples only, other embodiments may be bigger or smaller in terms of volume.

As shown in this figure, the depression 32 is at a center region 36 of the top surface 26. As such, the top surface 26 has a flat region 38 surrounding the center region 36. As depicted, the flat region 38 can annularly surround the center region 36. The flat region 38 is in thermal communication with the closed cavity 30 of the reservoir 12. In some embodiments, such as the one illustrated, the flat region 38 offers an infrastructure receiving surface 40 for some other types of infrastructures, as described below. For instance, the flat region 38 can be used as a heated floor for other infrastructures installed atop the infrastructure receiving surface 40.

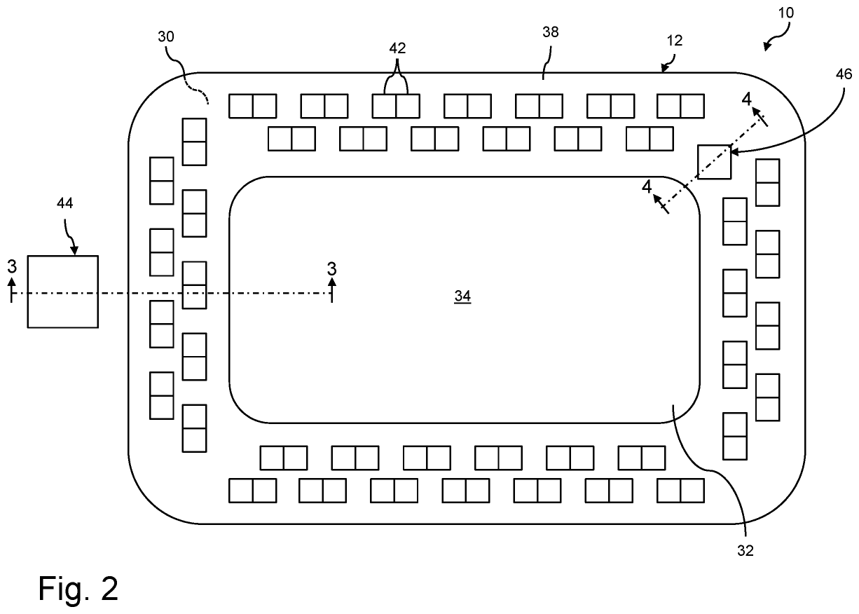

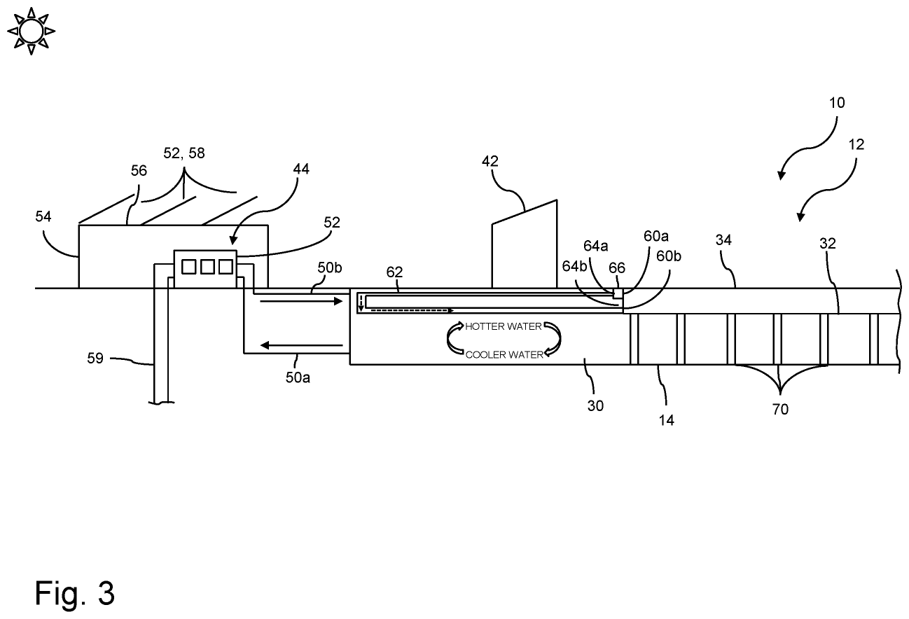

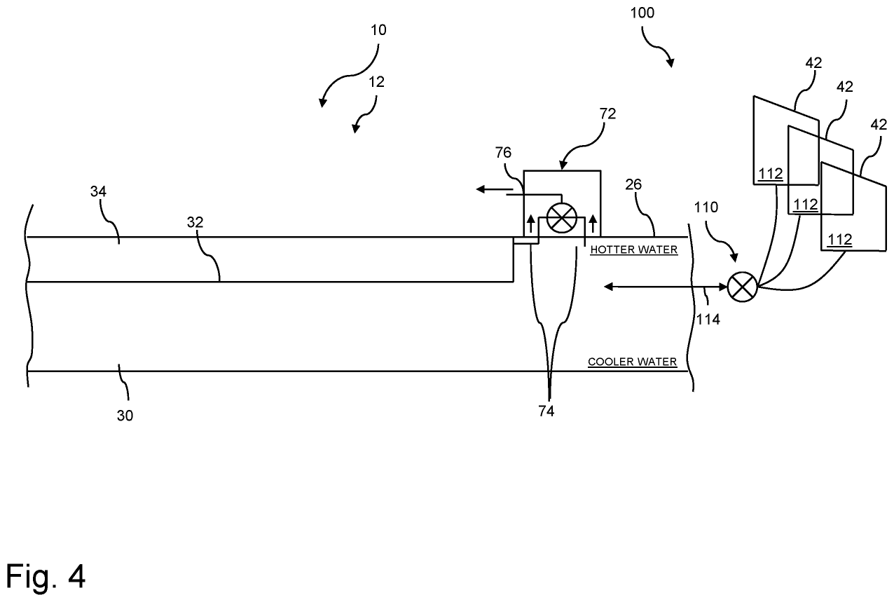

Referring now to FIG. 2, the flat region 38 surrounding the depression 32 receives a number of lodging units 42 in this example. As can be understood, as the whole body of liquid confined within the closed cavity 30 is heated to the first temperature, the flat region 38 can act as a heated floor for the lodging units 42, thereby reducing the amount of energy required to heat each of the lodging units 42 in cold climates, for instance. FIG. 2 also shows that the infrastructure 10 includes a heat generation unit 44 and a transition unit 46, which are discussed below with respect to FIGS. 3 and 4, respectively.

Referring now to FIG. 3, the heat generation unit 44 is in fluid communication with the closed cavity 30. More specifically, the heat generation unit 44 is configured for heating and/or maintaining the liquid confined within the closed cavity 30 to the first temperature, preferably at all times, e.g., day and night, 365 days a year. Although only one heat generation unit 44 is shown in this embodiment, there can be more than one similar heat generation units distributed about the reservoir 12 in other embodiments. Typically, it was found that within the closed cavity 30, colder liquid tends to lie at a bottom portion of the closed cavity 30 whereas hotter liquid tends to lie at a top portion of the closed cavity 30. This can be due to thermal convection occurring within the closed cavity 30. Accordingly, to enhance the efficiency of the heat generation unit 44, conduits 50a are used to pump liquid out of the closed cavity 30, and preferably out of the bottom portion of the closed cavity 30, and into the heat generation unit 44 for heating thereof. Similarly, once the liquid has been sufficiently heated within the heat generation unit 44, conduits 50b pumping liquid out of the heat generation unit 44 and back into the closed cavity 30, preferably into the top portion thereof, were found to be advantageous.

As shown, the heat generation unit 44 can include one or more heat generation systems 52 including, but not limited to, solar panel(s), geothermal heat unit(s), furnace unit(s), boiler unit(s), or a combination thereof. In some embodiments, the heat generation unit can include a combination of at least two of the solar panel unit, the geothermal heat unit, the furnace unit and the boiler unit. In some embodiments, the heat generation unit 44 is enclosed into an enclosure 54 such as a building and the like. In some embodiments, the enclosure 54 has a roof 56 onto which are positioned solar panels 58 receiving solar energy and transforming it into electricity used to power the heat generation unit(s) 44 inside the enclosure 54. The solar panels 58 may not be limited to the roof 56 of the enclosure 54 as a field of solar panels can be positioned on the ground around the heat generation unit 44, onto the lodging units 42 or anywhere on the property. In some other embodiments, such as the one illustrated, the heat generation unit 44 has a geothermal heat unit having an underground, geothermal conduit 59 running within the ground. The geothermal conduit 59 can be vertical and extend to a significant depth within the ground. In some other embodiments, the geothermal conduit runs horizontally underground, at a shallow depth such as between 1 and 3 meters, for instance. There can be one or more such geothermal conduits, depending on the application. The geothermal conduit 59 can be shallow geothermal wells. The geothermal unit can be configured in any way possible to maximize the capture of geothermal energy, which originates from the heat retained within the Earth since the original formation of the planet, from radioactive decay of minerals, and from solar energy absorbed at the surface and the like. Other types of heat generation units can be used such as wind power plants and the like.

In some embodiments, such as the one shown in FIG. 3, the depression 32 of the infrastructure 10 can have a least first and second openings 60a and 60b exposing the open cavity 34. As shown, the infrastructure 10 can have an inner conduit 62 extending within the closed cavity 30 and having first and second ends 64a and 64b hermetically connected to and in fluid communication with a respective one of the first and second openings 60a and 60b. As such, liquid received within the open cavity 34 can flow through the first opening 60a, along the inner conduit 62, and back into the open cavity 34 via the second opening 60b. In some embodiments, a pump 66 is provided to pump liquid out of the open cavity 34 and into the inner conduit 62. In this way, a least a portion of the thermal energy of the liquid confined within the closed cavity 30 can be transferred to the liquid running within the inner conduit 62 for heating purposes. In these embodiments, the inner conduit 62 is made of a thermally conductive material such as metal, for instance. The pump 66 can be omitted in some embodiments. In these latter embodiments, the inner conduit 62 preferably forms a circuit designed based on convection flows occurring naturally between the open and closed cavities 34 and 30 due to the reservoir's geometry.

Also shown in FIG. 3 are structural members 70 within the closed cavity 30 and extending between the base 14 and the depression 32 of the top surface. Other structural members 70 can be installed anywhere within the closed cavity 30 to reinforce its structural strength. As such, the structural members 70 can contribute to maintaining the integrity of the reservoir 12 at all times, regardless of whether the closed and open cavities 30 and 34 are filled with liquid. The structural members 70 can extend vertically or obliquely within the closed cavity 30. For instance, the structural members 70 can include, but not limited to, I-beams and the like. The structural members 70 can be made of any material having a sufficient strength. Preferably, the structural members 70 are corrosion resistant. Resistance to salt or other substances that can be used in the liquid is also preferable in some embodiments.

As best shown in FIG. 4, the infrastructure is provided with a transition unit 72 is in fluid communication with the open cavity 34 and the closed cavity 30 of the reservoir 12. The transition unit 72 is configured for cooling liquid confined within the closed cavity 30 to the second temperature using liquid received within the open cavity 34. Although only one transition unit 72 is shown in this embodiment, there can be more than one transition units distributed around the outer periphery of the open cavity 34 in other embodiments. In some embodiments, the cooling performed by the transition unit 72 involves mixing liquid from the closed cavity 30 with liquid from the open cavity 34. The transition unit 72 can thereby include, but not limited to, valve(s), liquid mixer(s), and the like. By doing so, no hot liquid from the closed cavity 30 directly reaches the open cavity 34 to avoid discomfort to people bathing therewithin, for instance. Typically, it was found that as hotter liquid tends to lie in a top portion of the closed cavity 30, the transition unit 72 can be configured to, using pump(s) and conduit(s) 74, pump the liquid preferably out of the top portion of the closed cavity 30 and into the transition unit 72. In the open cavity 34, as cooler liquid tends to go to the bottom portion of the open cavity 34, evaporation and contact with the surrounding environment can result in cooler liquid lying at the top portion of the open cavity 34. Accordingly, in these embodiments, the transition unit 72 can be configured to pump liquid out of the top portion of the open cavity 34 for mixing with the hotter liquid incoming from the closed cavity 30. The transition unit 72 can have a waterfall-like spout 76 delivering liquid into the open cavity 34. By a continuous and uninterrupted use of the transition unit 72, the liquid receiving within the open cavity 30 can be heated and maintained at the second temperature at all times. In some embodiments, the transition unit 72 can have a material addition unit configured for adding material into the water before it is delivered back into the open cavity 34. Examples of such materials include, but are not limited to, salt(s), anti-aging chemical(s), mineral(s), buoyancy enhancing chemical(s) or any other suitable chemical(s).

The transition unit 72 can be omitted in some embodiments. In embodiments where transition unit(s) is (are) omitted, the closed cavity 30 can be fluidly independent from the open cavity 34. Heating of the liquid within the open cavity 34 can be done using one or more inner conduits and one or more pumps such as those described above with reference to FIG. 3. In some embodiments, structural members (not shown) can be provided to ensure the integrity of the inner conduit(s) extending within the closed cavity 30.

FIG. 4 also shows an example of a system 100, in accordance with an embodiment. As depicted, the system 100 has buildings such as lodging units 42, an infrastructure 10 having a reservoir 12 defining a closed cavity 30 containing liquid at a first temperature, the reservoir 12 having a top surface 26 having a depression 32 forming an open cavity 34 containing liquid at a second temperature lower than the first temperature. The system 100 is provided with a heat generation unit (not shown) in fluid communication with the closed cavity 30. As discussed above, the heat generation unit is configured for at least one of heating and maintaining the liquid confined within the closed cavity to the first temperature. An example of the heat generation unit is described with reference to the heat generator unit 44 of FIG. 3. Referring back to FIG. 4, a heat exchange circuit is provided. The heat exchange circuit 110 circulates heat extracted from the liquid at the first temperature contained in the closed cavity 30 to the lodging units 42. In some embodiments, the heat exchange circuit 110 circulates a fluid heated by the liquid at the second temperature to heat exchangers 112 of the lodging units 42. In some embodiments, the fluid can be the liquid, e.g., the water, contained in the closed cavity 30. In some embodiments, the fluid can be a heated gas such as air carrying heat from the closed cavity to the buildings. Depending on the embodiment, heat exchanger conduits 114 can thereby carry heated water or air. Accordingly, the heat exchange circuit is a hot liquid circuit in some embodiments.

In some embodiments, the system 100 can be said to be self-sufficient. The reservoir 12 can act as a heat accumulator which produces and accumulates heat therewithin. The reservoir 12 can be used as a heat source to supply heat to buildings surrounding the reservoir 12. In some embodiments, excess heat generated by the buildings can be used to heat the liquid contained within the closed reservoir. Additionally or alternately, excess heat generated by the heat generation unit and/or the reservoir 12 can be used to heat the buildings. With such a circular model of energy exchange and the cyclical nature of heat production for buildings throughout the day or the year, the system 100 can switch from a mode where excess heat generated at the reservoir 12 is transferred to the lodging units 42 to a mode where excess heat generated at the lodging units 42 can be transferred to the reservoir 12, or vice versa. The mode switching can depend on the time of day, or on the time of year, for instance. In some embodiments, the system 100 can produce excess heat which can be shared or otherwise distributed to surrounding communities.

In a given embodiment, the energy needs of the system 100 can be met by a combination of solar energy, geothermal energy, biomass energy and excess heat coming from the reservoir 12. In a theoretical experiment, the system 100 can be equipped with a solar energy generator system producing about 31% of the energy needs of the system 100, a geothermal energy generator system producing about 35.3% of the energy needs of the system 100, a biomass energy production system producing about 11.1% of the energy needs of the system 100, and the excess heat generated at the reservoir 12 can account for about 22.8% of the energy needs of the system 100. Of course, these values can change depending on the construction of the system 100.

In some embodiments, the reservoir 12 acts as a heat accumulating infrastructure for the system 100. The heat accumulating infrastructure can allow the storage of excess energy produced by solar, geothermal or biomass boilers to be used in periods of high demand. It is therefore possible to reduce the size of the equipment and improve its operation in partial load. Considering that the volume of the heat accumulating infrastructure can be 11,000 m³, this volume allows the accumulation of more than 355,000 kWh of energy at a temperature of 70° C. As described above, the heat accumulating infrastructure consists of an insulated water reservoir, located on the mechanical room floor directly below the open cavity, which is heated to store or extract energy. In an example analysis, the reservoir 12 can be heated mostly with biomass.

In some embodiments, there is also described a method of operating an infrastructure such as the one described with reference to FIG. 1. The method can include a step of at least one of heating and maintaining liquid confined within the closed cavity to the first temperature. The method can also include a step of the liquid confined within the closed cavity at least one of heating and maintaining liquid received within the open cavity to a second temperature, the first temperature being greater than the first temperature. It is noted that the method can have a step of exchanging heat between the liquid confined within the closed cavity and liquid received in the open cavity. Another optional step of using structural members for supporting a weight of the liquid received in the open cavity can also be performed.

As can be understood, the examples described above and illustrated are intended to be exemplary only. For instance, in some embodiments, the infrastructure can include another basin receiving rain water which can be recycled for use within the infrastructure. In some embodiments, the closed cavity is a first cavity and the open cavity is a second cavity, with the second cavity being more open to a surrounding environment than the first cavity and/or less thermally insulated from the surrounding environment than the first cavity. The scope is indicated by the appended claims.

What is claimed is:

1. An infrastructure comprising: a reservoir having a base having a first periphery, a wall having a first wall portion hermetically mounted to the first periphery of the base, the first wall portion upwardly protruding to a second wall portion defining a second periphery, and a top surface hermetically mounted to the second periphery of the wall, inner surfaces of the base, the wall and the top surface collectively forming a closed cavity for receiving liquid at a first temperature, the top surface having a depression forming an open cavity for receiving liquid at a second temperature lower than the first temperature.

2. The infrastructure of claim 1 further comprising a heat generation unit in fluid communication with the closed cavity, the heat generation unit configured for at least one of heating and maintaining liquid confined within the closed cavity at the first temperature.

3. The infrastructure of claim 2 wherein the first temperature is above about 85° C., preferably above about 90° C. and most preferably of about 95° C.

4. The infrastructure of claim 2 wherein the heat generation unit includes at least one of a solar panel unit, a geothermal heat unit, a furnace unit and a boiler unit.

5. The infrastructure of claim 4 wherein the heat generation unit includes a combination of at least two of the solar panel unit, the geothermal heat unit, the furnace unit and the boiler unit.

6. The infrastructure of claim 1 further comprising a transition unit in fluid communication with the open cavity and the closed cavity, the transition unit configured for cooling liquid confined within the closed cavity to the second temperature using liquid from the open cavity.

7. The infrastructure of claim 6 wherein said cooling includes mixing liquid from the closed cavity with liquid from the open cavity.

8. The infrastructure of claim 6 wherein the second temperature being above 30° C., preferably above about 35° C. and most preferably of about 38° C.

9. The infrastructure of claim 1 wherein the liquid is water.

10. The infrastructure of claim 1 wherein the reservoir has a plurality of structural members within the closed cavity and extending between the base and the depression of the top surface.

11. The infrastructure of claim 1 wherein the depression is positioned at a center region of the top surface, the top surface having a flat region surrounding the depression, the flat region being in thermal communication with the closed cavity of the reservoir.

12. The infrastructure of claim 11 wherein the flat region has a plurality of buildings, the plurality of lodges being heated at least in part via the liquid at the first temperature contained within the closed cavity.

13. The infrastructure of claim 1 wherein the infrastructure has a hot liquid circuit in fluid communication with the closed cavity, the hot liquid circuit having one or more conduits circulating liquid at the first temperature outside the closed cavity.

14. The infrastructure of claim 13 wherein the hot liquid circuit is in heat exchange communication with a plurality of buildings surrounding the infrastructure.

15. The infrastructure of claim 1 wherein the reservoir has a height ranging between 1 and 5 meters, preferably between 2 and 4 meters and most preferably 3 meters, and wherein the depression has a depth ranging between 0.25 and 3 meters, preferably between 1 and 2 meters and most preferably 1 meters.

16. The infrastructure of claim 1 wherein the closed cavity has a volume ranging between 100 m³ and 10 000 m³, preferably between 500 m³ and 5 000 m³ and most preferably of 2 500 m³, the open cavity has a volume ranging between 50 m³ and 5 000 m³, preferably between 250 m³ and 2 500 m³ and most preferably of 1 250 m³.

17. The infrastructure of claim 1 wherein the depression has at least first and second openings, the infrastructure further comprising an inner conduit extending within the closed cavity and having first and second ends hermetically connected to and in fluid communication with a respective one of the first and second openings of the depression, wherein liquid received within the open cavity flows through the first opening, along the inner conduit, and back into the open cavity via the second opening.

18. The infrastructure of claim 17 further comprising a pump configured to circulate liquid out of the open cavity, into and along the inner conduit and back into the open cavity.

19. A method of operating an infrastructure having a reservoir having an inner surface defining a closed cavity and an outer surface having a depression defining an open cavity, the method comprising:
at least one of heating and maintaining liquid confined within the closed cavity at a first temperature; and
the liquid confined within the closed cavity at least one of heating and maintaining liquid received within the open cavity to or above a second temperature, the first temperature being greater than the second temperature.

20. The method of claim 19 further comprising exchanging heat between the liquid confined within the closed cavity and liquid received in the open cavity.

21. The method of claim 20 further comprising structural members supporting a weight of the liquid received in the open cavity.

22. A system comprising:
a plurality of buildings;
a heat accumulating infrastructure having a reservoir defining a first cavity containing liquid at a first temperature, the reservoir having a top surface having a depression forming a first cavity containing liquid at a second temperature lower than the first temperature;
a heat generation unit in fluid communication with the first cavity, the heat generation unit configured for at least one of heating and maintaining the liquid confined within the first cavity to the first temperature; and
a heat exchange circuit circulating heat extracted from the liquid at the first temperature contained in the first cavity to the plurality of buildings.

23. The system of claim 22 wherein the heat exchange circuit circulates a fluid heated by the liquid at the second temperature to heat exchangers of the plurality of buildings.

24. The system of claim 22 wherein the fluid is one of liquid contained in the first cavity and a heated gas.
